(19) United States
(12) Patent Application Publication
(10) Pub. No.: US 2009/0019112 A1
(43) Pub. Date: Jan. 15, 2009

(54) AUDIO AND VIDEO CONFERENCING USING MULTICASTING

(75) Inventors: Kenneth E. Venner, Las Flores, CA (US); Umer Khan, Irvine, CA (US)

Correspondence Address: FIALA & WEAVER, P.L.L.C.;C/O INTELLEVATE, P.O. BOX 52050, MINNEAPOLLS, MN, 55402, US

(73) Assignee: BROADCOM CORPORATION, Irvine, CA (US)

(21) Appl. No.: 11/776,177

(22) Filed: Jul. 11, 2007

(51) Int. Cl. G06F 15/16

(52) U.S. Cl. 709/204

(57) ABSTRACT

Methods, systems, and apparatuses for network-based conferencing are provided. A communication network includes a multicasting conferencing node and a plurality of computer systems. The computer systems have users that are participating in a network-based conference. The multicasting conferencing node is configured to receive a plurality of communication signals over a network from the plurality of computer systems. Each of the plurality of communication signals includes input content (e.g., voice, video, data, etc.) regarding the conference from a corresponding computer system. The multicasting conferencing node is configured to multicast the received input content from the node over the network to at least a portion of the plurality of computer systems. The multicasting conference node may be configured to combine the input content received in the plurality of communication signals prior to multicasting the received input content from the node over the network. Alternatively, each computer system may combine the content after it is received from the multicasting conference node in multicast signals.

### BACKGROUND OF THE INVENTION

1. Field of the Invention

The present invention relates to network-based conferencing.

2. Background Art

Network-based conferencing is becoming increasingly popular. Network-based conferencing refers to live meetings and/or presentations conducted over a network, such as the Internet. During such a conference, audio, video, data, and other types of information may be exchanged between the conference participants.

A network-based conference that occurs over the Internet is referred to as a “Web-based” conference or a “Web conference.” In a Web conference, participants communicate with other participants using a conferencing application, which connects together the computers of the participants. The conferencing application can be an application that is downloaded onto each of the participants' computers, or may be a Web-based application. For a Web-based application, participants typically enter a website address into their Web browser to attend the live meeting or conference.

A “webinar” is a type of Web conference where a presentation is made. During a webinar, typically a one way communication of the presentation occurs from the presenter to an audience. Such as webinar may be called a “webcast,” which is transmission of information in only one direction. A webinar can sometimes include interactive communications between the presenter and audience. During a webinar, a presenter may speak over a standard telephone line, or audio may be transmitted over a data network, such as the Internet (e.g., by using techniques of voice over IP (VOIP)), and the audience can respond in a like manner.

Today, every connection used for audio, video conferencing and data/application sharing in a network-based approach is a point-to-point feed. For example, each time a participant provides one or more of audio, video, or data input communication to the conference, a separate packet stream is transmitted over the network from that participant to each other participant. Thus, a network supporting a conference is loaded with a packet stream for each communication, targeted to each user. This can greatly load the network for large conferences. Such increased loading can lead to performance issues for the network, including slowing down communications, causing communication timeouts, etc.

Thus, what are needed are ways of performing network-based conferencing, while reducing the resulting load placed on the communication network.

### BRIEF SUMMARY OF THE INVENTION

Methods, systems, and apparatuses for network-based conferencing are provided. A communication network includes a multicasting conferencing node and a plurality of computer systems. The computer systems have associated users that are participating in a network-based conference. The multicasting conferencing node receives unicast-type communications from one or more of the participating computer systems providing content, and multicasts the content of the communications to the participating computer systems.

In an example implementation, the multicasting conferencing node is configured to receive a plurality of communication signals over a network from the plurality of computer systems. Each of the plurality of communication signals includes input content (e.g., voice, video, data, etc.) regarding the conference from a corresponding computer system. The multicasting conferencing node is configured to multicast the received input content from the node over the network to at least a portion of the plurality of computer systems.

In one example, the multicasting conference node may be configured to combine the input content received in the plurality of communication signals, and to multicast the combined input content over the network. Alternatively, the computer systems may each be configured to combine the input content after it is received in multicast signals transmitted by the multicasting conference node.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIGS. 1-4 show a communications network, including a plurality of computer systems coupled together by a network, where unicast and multicast communications are illustrated.

FIGS. 5 and 6 show block diagrams of example network-based conferencing systems.

FIG. 7 shows a flowchart providing example steps for network-based conferencing, according to an example embodiment of the present invention.

FIG. 8 shows a block diagram of a communications network configured for conferencing, according to an example embodiment of the present invention.

FIG. 9 shows a block diagram of an example multicasting conferencing node, according to an embodiment of the present invention.

FIG. 10 shows a block diagram of a communications network configured for conferencing, according to an example embodiment of the present invention.

FIG. 11 shows a block diagram of an example computer system configured to participate in a conference, according to an example embodiment of the present invention.

FIG. 12 shows a flowchart providing example steps for a computer system participating in a conference, according to an example embodiment of the present invention.

FIG. 13 shows a block diagram of an example computer system configured to participate in a conference, according to an example embodiment of the present invention.

FIG. 14 shows a flowchart providing example steps for network-based conferencing, according to an example embodiment of the present invention.

FIG. 15 shows a block diagram of a communications network configured for conferencing, according to an example embodiment of the present invention.

FIG. 16 shows a multicasting conferencing node that is an example of the multicasting conferencing node shown in FIG. 15, according to an embodiment of the present invention.

FIG. 17 shows a block diagram of a computer system in which embodiments of the present invention may be implemented.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### Examples of Network-Based Communications

Embodiments of the present invention relate to all types of network-based conferencing techniques. As mentioned above, network-based conferencing is used to conduct live meetings and/or presentations over a network, such as the Internet. A network-based conference that occurs over the Internet is referred to as a “Web-based” conference or a “Web conference.” In a Web conference, participants communicate with other participants over the Internet using a conferencing application. Computers of the participants are connected together by the conferencing application. The conferencing application can be an application that is downloaded onto each of the participants' computers, or may be a Web-based application. For a Web-based application, participants typically enter a website address into their Web browser to attend the live meeting or conference. Depending on the particular Web conference configuration, it may be possible to communicate audio, video, data, and/or other types of content from each participant to the other participants.

Such communications of content can occur over networks in a variety of ways. Two ways of providing information over a network include “unicasting” and “multicasting.” “Unicast” refers to point-to-point communications, where data packets are transmitted from a source to a single destination. “Multicast” refers to communications where data packets are transmitted from a source to a plurality of destinations simultaneously.

Unicasting and multicasting are illustrated as follows with reference to FIG. 1. FIG. 1 shows a communications network 100, including a plurality of computer systems 102a-102e coupled together by a network 104. Computer systems 102a-102e may be any type of computers, including desktop computers, mobile computers (e.g., laptop computers, handheld computers, personal digital assistants (PDAs), appliances, other electronics devices such as a television with built-in networking capability, etc.), servers, etc. Network 104 may be a local area network (LAN), a wide area network (WAN), the Internet, a further network type, or any combination of the same. Network 104 may be public or private, or a combination of both. Network 104 may include one or more nodes, which may each include one or more networking devices, such as a router, a switch, a bridge, a hub, a repeater, a gateway, etc., for mediating data transmitting through network 104, which may be any combination of wired and wireless communications.

FIG. 1 illustrates a unicast communication. In the example of FIG. 1, computer system 102a communicates with computer system 102b through network 104 in a unicast manner. As shown in FIG. 1, computer system 102a transmits a communication signal 108. Communication signal 108 includes information, which may be in the form of one or more data packets (e.g., Internet protocol (IP) packets), such as a data packet stream. Communication signal 108 is transmitted from computer system 102a (e.g., from a network interface card (NIC) or other communication interface of computer system 102a) over a first communication link 106a, and is received at network 104. Computer system 106b receives communication signal 108 from network 104 over a second communication link 106b. Communication signal 108 is a unicast transmission, because it is a point-to-point transmission (i.e., from computer system 102a to computer system 102b) through a network.

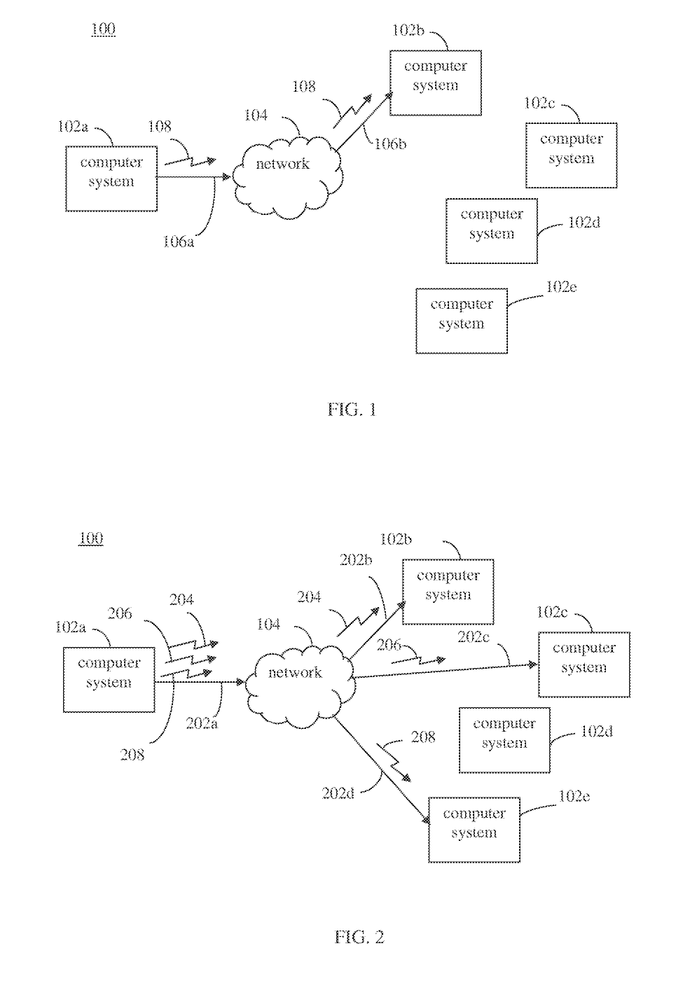

To communicate with multiple computer systems using unicast, a separate communication must be sent from the source to each destination. FIG. 2 shows network 100, where communications are occurring between multiple computer systems using unicast. In FIG. 2, computer system 102a intends to communicate the same information to each of computer systems 102b, 102c, and 102e (not to computer system 102d, however). Computer system 102a transmits a separate communication signal to each of computer systems 102b, 102c, and 102e, in a unicast manner. Computer system 102a transmits a first communication signal 204 (through a first communication link 202a, network 104, and a second communication link 202b) to computer system 102b. Computer system 102a transmits a second communication signal 206 (through first communication link 202a, network 104, and a second communication link 202c) to computer system 102c. Computer system 102a transmits a third communication signal 208 (through first communication link 202a, network 104, and a second communication link 202d) to computer system 102e. Thus, according to unicast, computer system 102a generated multiple separate communication signals 204, 206, and 208 (each including one or more data packets), each directed to a different destination, to convey the same information to each destination.

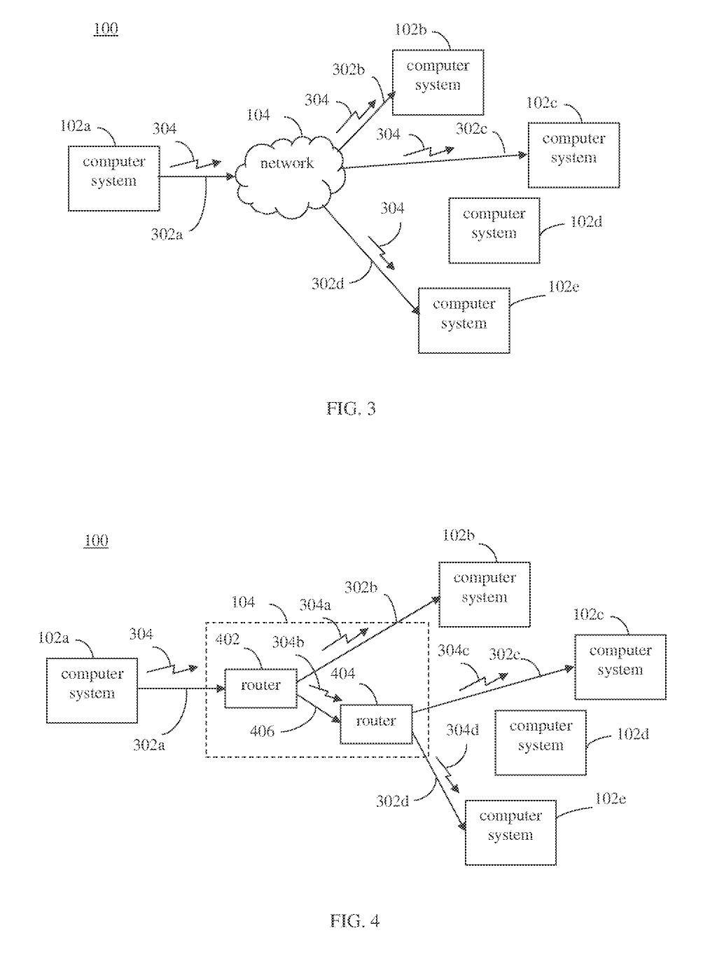

In contrast, multicast enables communications with multiple destinations while only transmitting a single communication signal from the source. For example, FIG. 3 shows network 100, where communications occur in a multicast manner. Similar to FIG. 2, in FIG. 3, computer system 102a intends to transmit the same information to each of computer systems 102b, 102c, and 102e (but not computer system 102d). Computer system 102a generates a communication signal 304 that includes the information desired to be transmitted. Communication signal 304 is transmitted over a first link 302a from computer system 102a to network 104. Communication signal 304 is transmitted from network 104 over a second link 302b to computer system 102b, over a third link 302c to computer system 102c, and over a fourth link 302d to computer system 102e. Each of computer systems 102b, 102c, and 102e receives the information of communication signal 304, even though communication signal 304 is a single signal transmission from computer system 102a.

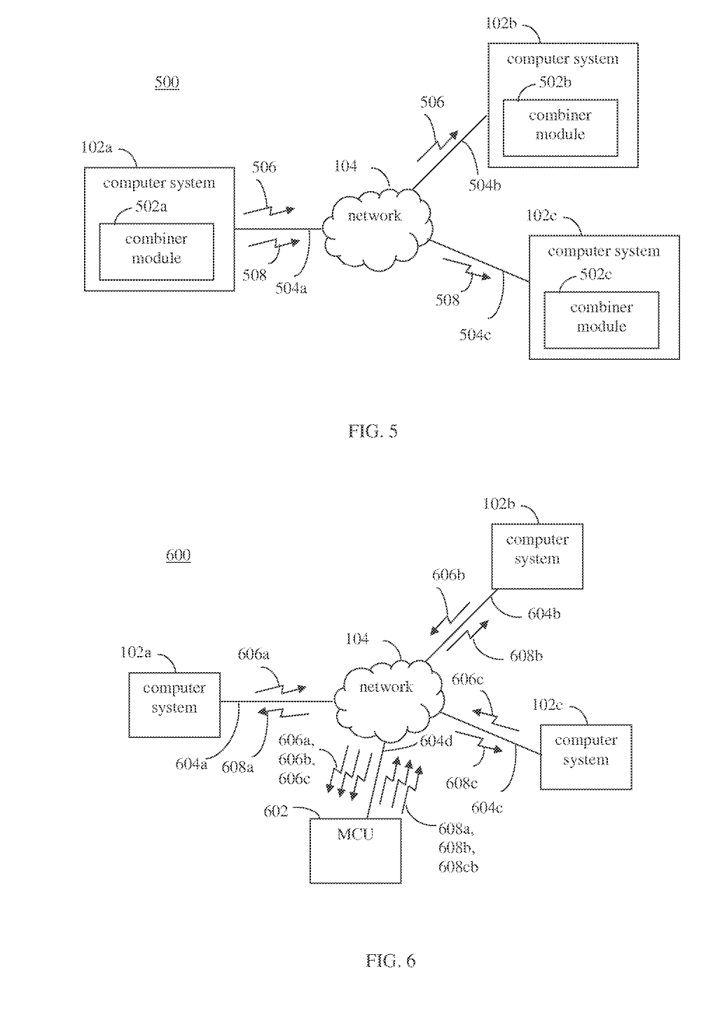

Multicast delivers information to multiple destinations simultaneously in an efficient manner, such as by transmitting the information signal over any particular link only once, creating copies of the information signal only when the links to the destinations split. According to multicast, communications signal 304 is provided to links 302b-302d by network 104 in an efficient manner determined according to the particular configuration of network 104. For example, FIG. 4 shows an example configuration of network 104, including a pair of networking devices, to illustrate how communication signal 304 may reach each of computer systems 102b, 102c, and 102e according to multicast. The implementation of network 104 shown in FIG. 4 is provided for illustrative purposes, as network 104 may have essentially an infinite number of possible configurations.

As shown in FIG. 4, network 104 includes a first router 402 and a second router 404. Communication signal 304 is received at first router 402 over link 302a. First router 402 splits communication traffic received on link 302a between link 302b and a communication link 406. For example, links 302b and 406 may be communication links of separate network segments. Copies of communication signal 304 (shown as signals 304a and 304b) are transmitted over links 302b and 406 from first router 402. Communication signal 304 is received at second router 404 as signal (copy) 304b over link 406. Second router 404 splits communication traffic received on link 406 between link 302c and link 302d. Copies of communication signal 304 (shown as signals 304c and 304d) are transmitted over links 302c and 302d from second router 404.

As shown in FIG. 4, information is communicated from computer system 102a to computer systems 102b, 102c, and 102e in a multicast manner, using communication signal 304, without repeating transmission of a communication signal over any particular link. This contrasts to the implementation of FIG. 2, where information is communicated from computer system 102a to computer systems 102a, 102c, and 102e in a unicast manner, using multiple communications signals 204, 206, and 208, which are all transmitted over link 302a from computer system 102a, and one or more of which may transit one or more of the same links of network 104. Thus, a multicast transmission can be configured to reach multiple destinations at a lower network load level than the multiple unicast transmissions required to reach the same destinations.

Unicast and multicast use different mechanisms to reach destinations. With regard to unicast, a source device inserts an IP (Internet protocol) address of the destination device as the IP destination address in transmitted data packets. With regard to multicast, several communication mechanisms exist. “Multicast” typically refers to “IP Multicast,” but it intended herein to encompass further multicasting techniques, including those described elsewhere herein.

IP Multicast is an implementation of multicasting on the IP routing level, where routers create optimal distribution paths for datagrams sent to a multicast destination address spanning tree in real time. IP Multicast scales to large receiver populations by not requiring prior knowledge of whom or how many receivers there are. As described above, the source device sends a packet once, even if it needs to be delivered to a large number of destination devices. The nodes in the network handle replicating the packet to reach multiple destinations where necessary. IP Multicast uses an IP multicast group address, a multicast distribution tree, and receiver driven tree creation.

The IP multicast group address is used by source devices and destination devices to send and receive content. Sources devices use the group address as the IP destination address in their data packets. Destination devices use the group address to inform the network that they are interested in receiving packets sent to that particular group. For example, if content is associated with group 226.1.1.1, the source device sends data packets destined for 226.1.1.1. Destination devices intending to receive the content inform the network that they are interested in joining group 226.1.1.1, and are subsequently added to the IP multicast group. The protocol used by destination devices to join a group is called the Internet Group Management Protocol or IGMP, and would be known to persons skilled in the relevant art(s).

After destination devices join a particular IP multicast group, a multicast distribution tree is generated for that group. The protocol typically used to generate the multicast distribution tree is Protocol Independent Multicast or PIM. PIM sets up multicast distribution trees such that data packets from source devices to a particular multicast group reach the destination devices that have joined the group. For example, all data packets sent to the group 226.1.1.1 are received by destination devices that joined 226.1.1.1. Several types of PIM currently exist, including Sparse Mode (SM), Dense Mode (DM), Source Specific Mode (SSM) and Bidirectional Mode (Bidir), as would be known to persons skilled in the relevant art(s).

While IP Multicast uses a designated multicast address, another type of multicasting, called Explicit Multi-Unicast (XCAST), includes a list of unicast addresses in a data packet of all the destination devices intended to receive the data packet. The XCAST model generally assumes that the computer systems participating in the communication are known ahead of time, so that distribution trees can be generated and resources allocated by network elements in advance of actual data traffic.

Multicast techniques have been used in applications such as music on hold, lectures (e.g., distance learning, televised company meetings, etc.), providing television over Internet, distributing stock data, etc.

### Example Conventional Conferencing Techniques

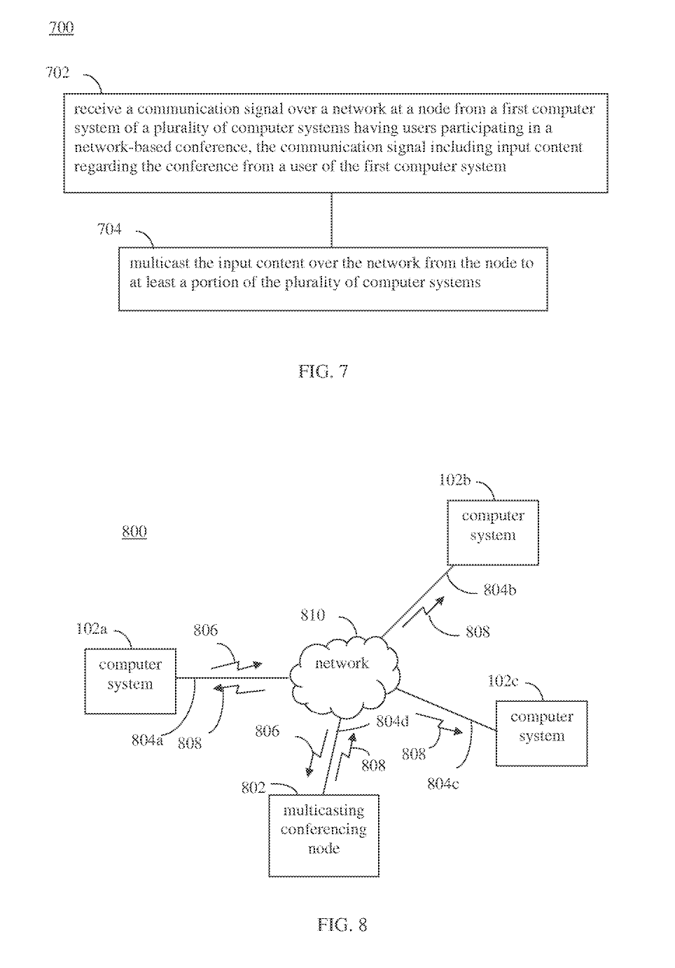

Available audio and video conferencing systems use point-to-point, unicast type feeds. For example, FIGS. 5 and 6 show networks 500 and 600, respectively, which are configured for conferencing. Networks 500 and 600 are similar to network 100, including computer systems 102a-102c communicatively coupled together by network 104. Three computer systems 102a-102c are shown for ease of illustration in FIGS. 5 and 6, although any number of computer systems 102 may be present. Participant humans (not shown in FIGS. 5 and 6) use computer systems 102a-102c to communicate with each other in a live Web conference, which may include content such as audio (e.g., voice), video, data, etc. A participant may use a respective one of computer systems 102a-102c to interact with the participants at the others of computer systems 102a-102c by providing at least one of audio, video, data, etc.

In network 500, computer systems 102a-102c each include a respective one of combiner modules 502a-502c. A combiner module 502 is used in a particular computer system 102 to combine the input content (e.g., audio and/or video) provided by the participants at the other computer systems 102, for output at the particular computer system 102. For example, in FIG. 5, a participant provides audio and/or video at computer system 102a. Computer system 102a transmits a separate communication signal to each of computer systems 102b and 102c in a unicast manner. Computer system 102a transmits a first communication signal 506 (through a first communication link 504a, network 104, and a second communication link 504b) to computer system 102b. Computer system 102a transmits a second communication signal 508 (through first communication link 504a, network 104, and a second communication link 504c) to computer system 102c. First and second communication signals 506 and 508 include the same audio, video, and/or other content supplied to the conference by the participant(s) using computer system 102a. First and second communications signal 506 and 508 may be transmitted according to any audio and/or video communication protocol and/or standard, such as ITU H.323, which is a standard for video over Internet Protocol (IP) and for voice over IP (VoIP).

Because system 500 is a conventional system using unicast communications, first and second communication signals 506 and 508 must both be transmitted, even though they contain the same conferencing information (e.g., voice, video, etc.), to provide the information to both of computer systems 102b and 102c. In a similar fashion, computer system 102b transmits separate communication signals to computer systems 102a and 102c, and computer system 102c transmits separate communication signals to computer systems 102a and 102b, each time their respective participants input content to the conference.

In the example of FIG. 5, combiner module 502b combines the conferencing information received in signal 506 from computer system 102a, with any conferencing information received in an analogous signal from computer system 102c. Combiner module 502b generates combined conferencing information that can be provided by computer system 102b to its conference participant(s). For example, computer system 102b may include a speaker to output combined audio information of the conference (e.g., combined voice of participants at computer systems 102a and 102c combined), and may include a video monitor to output combined video information of the conference (e.g., combined video feeds from participants at computer systems 102a and 102c).

Thus, in the conferencing configuration of network 500 shown in FIG. 5, each computer system 102 receives unicast conferencing information from each other participant computer system, and combines the received conferencing information for local output. For example, network 500 may use a standards-based H.323 technique known as “decentralized multipoint”, where each computer system 102 exchanges video and audio directly with the other computer systems of the conference with no central “manager” or other bottleneck. An advantage of this is that the video and audio may be of higher quality, because it does not have to be relayed through a central point. Furthermore, participants can make ad-hoc multipoint calls without any concern regarding the availability or control of a central point. This added convenience and quality comes at the expense of some increased network bandwidth (which may be problematic across lower bandwidth networks), processing overhead, and scalability issues, because each computer system 102 must transmit to every other computer system directly.

In the conferencing configuration of FIG. 6, network 600 includes a central manager or point called a multipoint control unit (MCU) 602. MCU 602 is a device conventionally used to bridge audio and video conferencing connections. MCU 602 receives conference information from each of computer systems 102a-102c in a unicast manner, combines the received conference information, and transmits the combined conference information to each of computer systems 102a-102c in a unicast manner.

For example, as shown in FIG. 6, computer system 102a transmits a first communication signal 606a that includes conference information content provided by a participant(s) of the conference at computer system 102a. Computer system 102b transmits a second communication signal 606b that includes conference information content provided by a participant(s) of the conference at computer system 102b. Computer system 102c transmits a third communication signal 606c that includes conference information content provided by a participant(s) of the conference at computer system 102c. Communication signals 606a-606c are transmitted in a unicast manner, directed to MCU 602. MCU 602 receives each of communication signals 606a-606c. MCU 602 combines together the conference information received in each of signals 606a-606c. MCU 602 generates fourth, fifth, and sixth communication signals 608a-608c, which each include the same combined conference information, and transmits them to computer systems 102a-102c, respectively, in a unicast manner.

In conventional systems 500 and 600, unicast communications are used, either directly between computer systems 102, or between computer systems 102 and a central point (e.g., MCU 602). Thus, each time a participant provides an audio and/or video input communication to the conference, a separate packet stream is generated from the participant directly to each other participant, or to a central point, which generates a separate packet stream transmitted back to each participant. The network supporting the conference is loaded with a packet stream for each communication, for each user. This can greatly load the network, particularly for large conferences and/or low bandwidth networks. Such increased loading can lead to performance issues for the network, including slowing down communications, causing communication timeouts, etc. Embodiments of the present invention overcome these deficiencies of conventional conferencing systems, providing a reduced load on a network. Example embodiments of the present invention are described in detail in the following section.

### Example Embodiments of the Present Invention for Conferencing Using Multicasting

The example embodiments described herein are provided for illustrative purposes, and are not limiting. The examples described herein may be adapted to any type of network-based conferencing system. Furthermore, additional structural and operational embodiments, including modifications/alterations, will become apparent to persons skilled in the relevant art(s) from the teachings herein.

In embodiments of the present invention, content (e.g., audio, video, data, etc.) provided by users participating in a conference is received at a common node. The provided content is multicast from the node to the participating users. In this manner, unicast communications between the users participating in the conference, and/or unicast communications to and from a conventional MCU, are avoided, reducing the network load and saving network bandwidth.

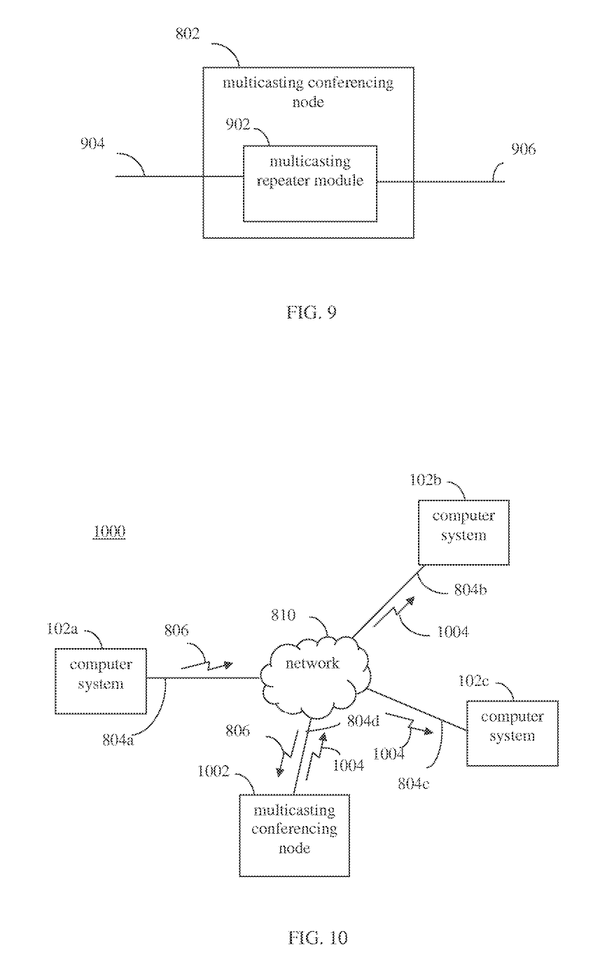

For example, FIG. 7 shows a flowchart 700 providing example steps for network-based conferencing, according to an example embodiment of the present invention. FIG. 7 is described with respect to FIG. 8 for illustrative purposes. FIG. 8 shows a communications network 800, according to an example embodiment of the present invention. Network 800 includes computer systems 102a-102c, and a multicasting conferencing node 802, that are communicatively coupled together through a network 810. Other structural and operational embodiments will be apparent to persons skilled in the relevant art(s) based on the discussion regarding flowchart 700. Flowchart 700 is described as follows.

Flowchart 700 begins with step 702. In step 702, a communication signal is received over a network at a node from a first computer system of a plurality of computer systems having users participating in a network-based conference, the communication signal including input content regarding the conference from a user of the first computer system. For example, as shown in FIG. 8, computer system 102a transmits a communication signal 806 over a communication link 804a through network 810. Multicasting conferencing node 802 receives communication signal 806 from network 810 over a communication link 804d. Communication signal 806 includes content (e.g., audio such as user voice, video, data, etc.) related to the conference that is input by a user of computer system 102a participating in the conference. Communication signal 806 may be transmitted according to any audio and/or video communication protocol and/or standard, such as ITU H.323, which is a standard for video over Internet Protocol (IP) and for voice over IP (VoIP).

In step 704, the input content is multicast over the network from the node to at least a portion of the plurality of computer systems. As shown in FIG. 8, multicasting conferencing node 802 transmits a communication signal 808 in a multicast manner to network 810 over communication link 804d. Communication signal 808 includes the content input by the user of computer system 102a received in communication signal 806. Computer system 102a receives communication signal 808 from network 810 over communication link 804a. Computer system 102b receives communication signal 808 from network 810 over communication link 804b. Computer system 102c receives communication signal 808 from network 810 over communication link 804c.

In the manner of flowchart 700, the participants of the conference at computer systems 102a-102c receive the content input to the conference by a user of computer system 102a in a multicast manner, rather than loading the network with communication signals generated for each participant in a conventional unicast system. Examples of the input content can include audio (such as a voice of a user participant), video (such as a video image of a participant and/or a whiteboard), data (such as a web share application for sharing a document, etc.), and other types of interactive content.

Note that multicasting conferencing node 802 can be located anywhere, as long as it is communicatively coupled to network 810. For example, as shown in FIG. 8, node 802 can be located separately from the participating computer systems 102. Alternatively, node 802 can be located in one of computer systems 102. For example, node 802 may be located in a computer system 102 having a user that is performing the sharing of a document to participants of the conference (e.g., sharing a Microsoft Powerpoint document, operating a web sharing application, etc.) or is providing other content to the conference. The multicasting conferencing node 802 may also be a part of an MCU or another server or device.

Steps 702 and 704 of flowchart 700 can be repeated any number of times for subsequent content provided by any of computer systems 102a-102c during the conference. For example, in a similar manner, a second communication signal containing content can be received from any one of computer systems 102a-102c (according to step 702), that is multicast to computer systems 102a-102c by node 802 (according to step 704).

As described above, communication signal 808 transmitted by node 802 includes the content received in communication signal 806. Thus, in an embodiment, node 802 operates as a form of repeater. For instance, FIG. 9 shows a multicasting conferencing node 900, which is an example embodiment for multicasting conferencing node 802 shown in FIG. 8. As shown in FIG. 9, node 900 includes a multicasting repeater module 902. Multicasting repeater module 902 receives a unicast communication signal 904 (e.g., communication signal 806 of FIG. 8) from an entity, and generates a multicast communication signal 906 (e.g., communication signal 808 of FIG. 8) that is received by a plurality of entities. In FIG. 9, multicasting repeater module 902 is configured to retransmit content received in a single communication signal to be received by a plurality of entities (e.g., computer systems 102a-102c) in a multicast manner. Multicasting repeater module 902 may be configured according to any type of multicast, including those described elsewhere herein or otherwise known. For example, in an IP Multicast embodiment, repeater module 902 may generate data packets that include a multicast group address. In an Explicit Multi-Unicast embodiment, repeater module 902 may generate data packets that include a list of the unicast addresses of the destination devices intended to receive the data packets.

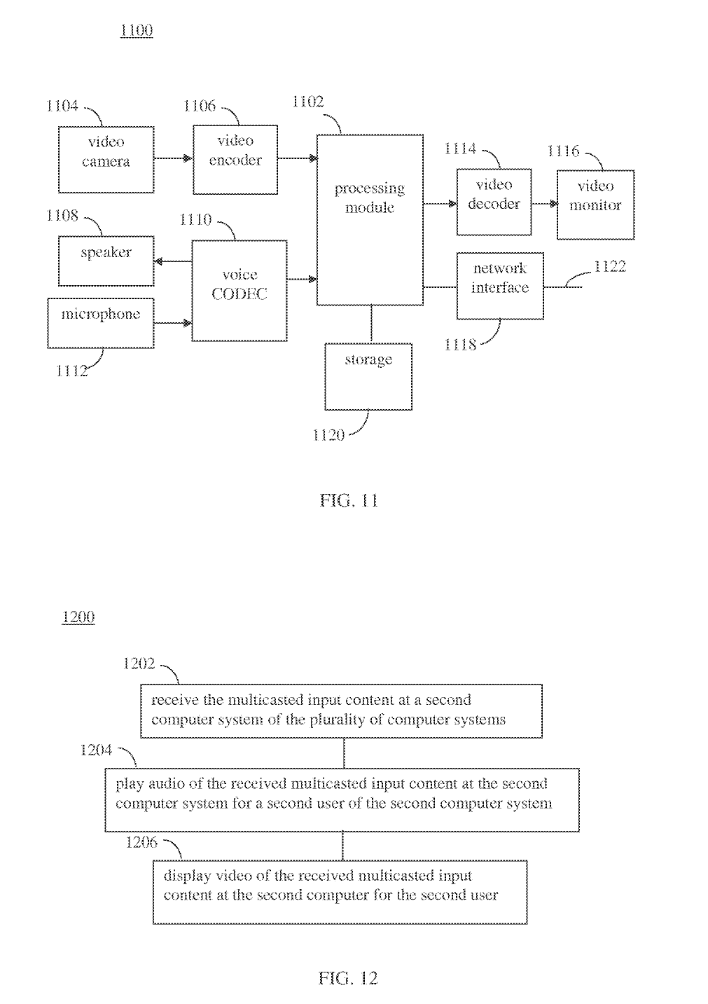

In the embodiment of FIG. 8, computer system 102a received multicast communication signal 808 containing the content that computer system 102a provided to node 802. FIG. 10 shows a communication network 1000, according to another embodiment of the present invention. Network 1000 is similar to network 800 of FIG. 8, having a multicasting conferencing node 1002 instead of multicasting conferencing node 802. In FIG. 10, multicasting conferencing node 1002 receives communication signal 806 from computer system 102a. Node 1002 multicasts the content of communication signal 806 as communication signal 1004 over network 810 to all computer systems (102b and 102c) participating in the conference except for computer system 102a. This is because, in an embodiment, the user of computer system 102a does not need to interact with its own provided content. For example, the user of computer system 102a does not need to hear its own voice, view its own video image, etc., and thus communication signal 1004 is not multicast to computer system 102a.

In another embodiment, node 1002 transmits a communication signal tailored to computer system 102a (while multicasting to the other computer systems) that includes some content provided by the user of computer system 102a (e.g., data, such as a Microsoft Powerpoint document), but not some other content provided by the user of computer system 102a (e.g., audio).

Computer systems 102 can be configured for conferencing in a variety of ways. FIG. 11 shows a computer system 1100 that is an example of computer system 102, according to an example embodiment of the present invention. Computer system 1100 is configured for audio, video, and data conferencing, but in alternative embodiments, may be configured for alternative types of conferencing.

As shown in FIG. 11, computer system 1100 includes a processing module 1102, a video camera 1104, a video encoder 1106, a speaker 1108, a voice CODEC 1110, a microphone 1112, a video decoder 1114, a video monitor 1116, a network interface 1118, and storage 1120. These components of computer system 1100 are further described as follows. Further description of some of these components of computer system 1100, and description of additional possible components for computer system 1100, is provided below with respect to FIG. 17.

Processing module 1102 is coupled to each of video encoder 1106, voice CODEC 1110, video decoder 1114, network interface 1118, and storage 1120. Processing module 1102 may be individually connected to these components, or one or more of these components may be connected to processing module 1102 in a common bus structure.

Video camera 1104 and video encoder 1106 may be present in video conferencing applications. When present, video camera 1104 captures video images, as configured by one or more users of computer system 1100. For example, video camera 1104 may capture still or video images of the one or more users at computer system 1100 participating in a conference, may capture video images of a white board or other board, may capture video images of a lecture, and/or may capture any other video of interest to a conference. Video camera 1104 may be a webcam or other type of video camera that can capture still photographs, video data, and which can be coupled into computer system 1100. Video camera 1104 generates a video stream that is received by video encoder 1106. The video stream may include digital data, or analog information that is converted to digital form by an analog-to-digital (A/D) converter of video encoder 1106. Video encoder 1106 encodes (e.g., compresses) the video data of the received video stream. Video encoder 1106 generates an encoded video data stream that is received by processing module 1102.

Microphone 1112 and voice CODEC 1110 may be present in audio conferencing applications. When present, microphone 1112 captures audio, as configured by one or more users of computer system 1100. For example, microphone 1112 may capture voice and/or other sounds generated by the one or more users participating in the conference through computer system 1100, may capture lecture audio, and/or may capture any other audio of interest to a conference. Microphone 1112 may be any type of microphone. Microphone 1112 generates an audio stream that is received by voice CODEC 1110. The audio stream may include digital data, or analog information that is converted to digital form by an analog-to-digital (A/D) converter of voice CODEC 1110. Voice CODEC 1110 encodes (e.g., compresses) the audio data of the received audio stream. Voice CODEC 1110 generates an encoded audio data stream that is received by processing module 1102.

Processing module 1102 receives the encoded video and/or audio streams from video encoder 1106 and voice CODEC 1110. Processing module 1102 may buffer video and/or audio data in storage 1120. Storage 1120 may include any suitable type of storage, including one or more hard disc drives, optical disc drives, FLASH memory devices, etc. Processing module 1102 streams the video and/or data to network interface 1118.

Network interface 1118 interfaces computer system 1100 with a communications network 1122 (e.g., network 810 shown in FIGS. 8 and 10). For example, in an embodiment, network interface 1118 is a network interface card (NIC) for interfacing with an Ethernet network. In embodiments, network interface 1118 may be configured to enable a wired and/or wireless connection with communications network 1122. For example, network interface 1118 may enable a wireless local area network (WLAN) link (including an IEEE 802.11 WLAN standard link), and/or other type of wireless communication link. Communications network 1122 may be a local area network (LAN), a wide area network (WAN), the Internet, or other network.

Network interface 1118 generates a stream of data packets that include the video and/or audio data content, and transmits the data packet stream to a multicasting conferencing node (e.g., node 802 of FIG. 8 or node 1002 of FIG. 10). For instance, the data packet stream may be transmitted in a unicast manner, by including an IP address of the multicasting conferencing node in the data packets. Network interface 1118 receives a stream of data packets from the multicasting conferencing node that include audio, video, and/or other conference-related content from other computer systems of the conference. Network interface 1118 generates a data stream that includes the content, which is received by processing module 11102.

Processing module 1102 extracts the audio data and/or video data from the received data stream. In an embodiment, processing module 1102 includes a digital signal processor (DSP). When present, the DSP may apply special effects to the received audio data (e.g., an equalization function) and/or video data. Processing module 1102 may buffer the received video and/or audio data in storage 1120. Processing module 1102 provides the data to video decoder 1114, and the audio data to voice CODEC 1110.

Video decoder 1114 receives and decodes (e.g., decompresses) the video data. Video decoder 1114 generates a video data stream (analog or digital), which is received by video monitor 1116. Video monitor 1116 displays video images corresponding to the received video data. For example, video monitor 1116 may display multiple panels of video, each panel corresponding to a different participant of the conference. Video monitor 1116 may include any type of display mechanism, including a cathode ray tube (CRT) monitor, a flat panel monitor (e.g., an LCD (liquid crystal display) panel), or other display mechanism.

Voice CODEC 1110 performs bit stream decoding of the received audio data (if needed) and converts the decoded data to an analog signal. Speaker 1108 receives the analog signal, and outputs corresponding sound (e.g., voice). For example, speaker 1108 may output sound that is a combination of the voices of the participants of the conference. The combination of voices may or may not include the voice(s) of the user(s) of computer system 1100, depending on the particular implementation.

Video encoder 1106, voice CODEC 1110, and video decoder 1114 may be implemented in hardware, software, firmware, and/or any combination thereof. Video encoder 1106, voice CODEC 1110, and video decoder 1114 may be configured to perform encoding and/or decoding of data according to proprietary and/or conventional audio and/or video data compression/decompression/encoding/decoding standards, such as those mentioned elsewhere herein or otherwise known. In an embodiment, video encoder 1106 and video decoder 1114 may be combined in a video CODEC.

Thus, in embodiments, computer system 1100 may be used to capture video and/or audio to contribute to a conference, and to receive and display video and/or to receive and play audio related to the conference. Furthermore, in an embodiment, computer system 1100 may be used to contribute data to a conference and/or to receive data related to a conference. For example, computer system 1100 may enable a user to operate a program, such as a Microsoft Powerpoint, which generates data that is transmitted to other conference participants according to embodiments of the present invention.

In an embodiment, computer system 1100 is configured to perform the steps of flowchart 1200 shown in FIG. 12, which may be additional steps to flowchart 700 shown in FIG. 7. In step 1202, the multicasted input content is received at a second computer system of the plurality of computer systems. For example, as shown in FIG. 8, computer system 102b may receive content from computer system 102a in multicast communication signal 808. In an embodiment, computer system 102b may be configured similarly to computer system 1100 of FIG. 11. Thus, computer system 102b may receive the content from node 802 using network interface 1118.

In step 1204, audio of the received multicasted input content is played at the second computer system for a second user of the second computer system. As described above, speaker 1108 may play audio of the received content.

In step 1206, video of the received multicasted input content is displayed at the second computer for the second user. As described above, video monitor 1116 may display video of the received content.

In step 1208, data of the received multicasted input content is provided at the second computer for the second user. For example, video monitor 1116 may display data of the received content, such as a Microsoft Powerpoint document. Thus, according to flowchart 1200, a participant at a computer system may receive and interact with (e.g., listen to, view, etc.) the multicasted content.

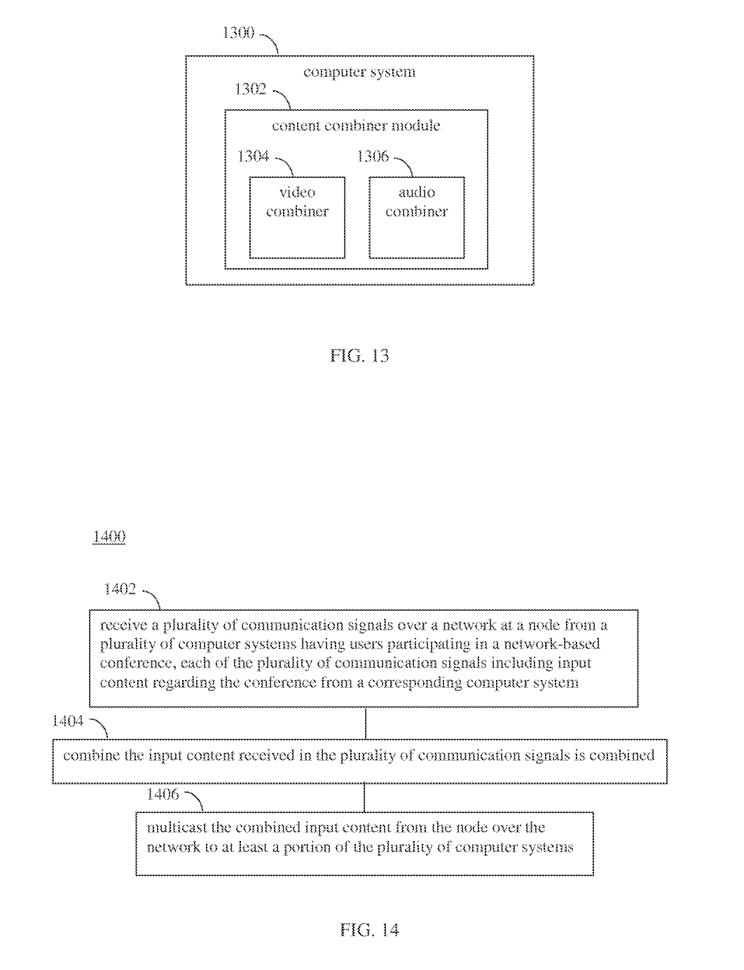

In the embodiment of flowchart 700, a computer system may receive multicast content from more than one other computer system close enough in time such that the content must be combined. FIG. 13 shows a computer system 1300, which is an example of computer system 102 shown in FIGS. 8 and 10. In FIG. 13, computer system 1300 includes a content combiner module 1302. Content combiner module 1302 is configured to combine content received from a multicasting conferencing node (e.g., node 802 or 1002) in two or more multicast communications relating to two or more other computer systems. For example, as shown in FIG. 13, combiner module 1302 may include a video combiner 1304, an audio combiner 1306, and/or a data combiner 1308. Video combiner 1304, when present, is configured to combine video content relating to different computer systems. For example, video combiner 1304 may be configured to generate a signal corresponding to a multi-panel video image. Audio combiner 1306, when present, is configured to combine audio content relating to different computer systems. For example, audio combiner 1306 may be configured to overlay voice data received from the different computer systems into a single audio data stream, so that it can be simultaneously played by a common speaker. Data combiner 1308, when present, is configured to combine data content relating to different computer systems. For example, data combiner 1308 may be configured to combine data signals received from the different computer systems into a single data stream, so that it can be simultaneously displayed or otherwise interacted with. Video, audio, and data combiners 1304, 1306, and 1308 may be implemented in hardware, software, firmware, or any combination thereof. For example, video, audio, and data combiners 1304, 1306, and 1308 may include conventional MCU functionality for combining audio and video streams. Techniques for video and audio combination will be known to persons skilled in the relevant art(s).

In the embodiments described just above, computer systems participating in a conference locally combine the conference content received in a multicast manner from the multicasting conferencing node. In another embodiment, the multicasting conferencing node may perform the content combining. For example, FIG. 14 shows a flowchart 1400 providing example steps for network-based conferencing, according to an example embodiment of the present invention. FIG. 14 is described with respect to FIG. 15 for illustrative purposes. FIG. 15 shows a communications network 1500, according to an example embodiment of the present invention. Network 1500 includes computer systems 102a-102c, and a multicasting conferencing node 1502, that are communicatively coupled together through network 810. Other structural and operational embodiments will be apparent to persons skilled in the relevant art(s) based on the discussion regarding flowchart 1400. Flowchart 1400 is described as follows.

Flowchart 1400 begins with step 1402. In step 1402, a plurality of communication signals are received over a network at a node from a plurality of computer systems having users participating in a network-based conference, each of the plurality of communication signals including input content regarding the conference from a corresponding computer system. For example, as shown in FIG. 15, computer system 102a transmits a communication signal 1506 over a communication link 1504a through network 810, computer system 102b transmits a communication signal 1508 over a communication link 1504b through network 810, and computer system 102c transmits a communication signal 1510 over a communication link 1504c through network 810. Multicasting conferencing node 1502 receives communication signals 1506, 1508, and 1510 from network 810 over a communication link 1504d. Communication signals 1506, 1508, and 1510 each include content (e.g., audio such as user voice, video, data, etc.) related to the conference that is input by users of computer systems 102a, 102b, and 102c, respectively.

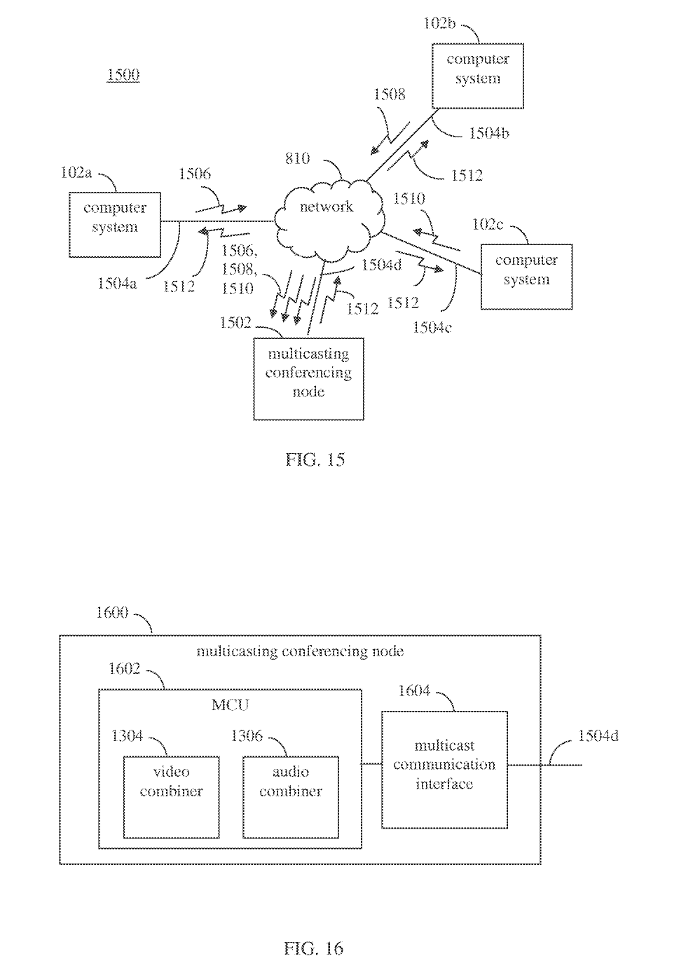

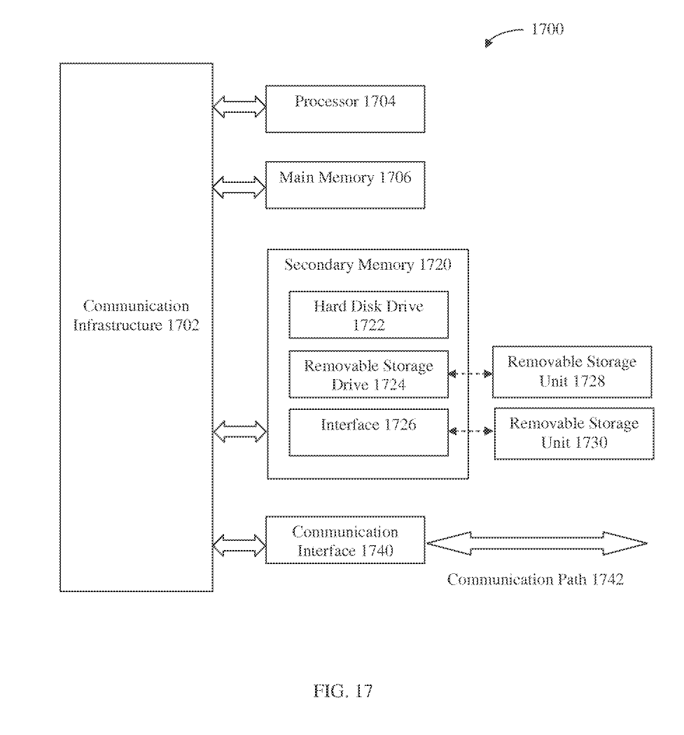

In step 1404, the input content received in the plurality of communication signals is combined. Multicasting conferencing node 1502 combines the content received in communication signals 1506, 1508, and 1510. For instance, FIG. 16 shows a multicasting conferencing node 1600 that is an example of node 1502 shown in FIG. 15. As shown in FIG. 16, multicasting conferencing node 1600 includes video combiner 1304, audio combiner 1306, and data combiner 1308. As described above, video combiner 1304, when present, is configured to combine video content relating to different computer systems. For example, video combiner 1304 may be configured to combine some or all of the video data included in communication signals 1506, 1508, and 1510. Audio combiner 1306, when present, is configured to combine audio content relating to different computer systems. For example, audio combiner 1306 may be configured to combine some or all of the audio data included in communication signals 1506, 1508, and 1510. Data combiner 1308, when present, is configured to combine data content relating to different computer systems. For example, data combiner 1308 may be configured to combine some or all of the application data included in communication signals 1506, 1508, and 1510. In an embodiment, as shown in FIG. 16, node 1600 may include an MCU 1602, which includes video, audio, and/or data combiners 1304, 1306, and 1308.

For example, in some situations, video, audio, and data combiners 1304, 1306, and 1308, when present, may combine just a portion of the information included in communication signals 1506, 1508, and 1510. In some situations, a conference participant may not be providing content to the conference, and thus their respective communication signal may not exist, or may be present but may be ignored. For instance, a participant may not be speaking, or may have pressed a “mute” button. Thus, the participant may not be providing any audio data, or if they are providing a stream of audio data, the stream of audio data may be ignored by audio combiner 1306. In another example where an application (or other data) is being shared in a conference, it may be the case that only one participant is interacting with the application at a time, or that fewer than all participants are simultaneously interacting with the application (e.g., using split screen, etc.). Thus, in some situations, one or more, but less than all of communication signals 1506, 1508, and 1510 may be combined by data combiner 1308, while the other communication signals are ignored.

In step 1406, the combined input content is multicasted from the node over the network to at least a portion of the plurality of computer systems. As shown in FIG. 15, multicasting conferencing node 1502 transmits a communication signal 1512 in a multicast manner to network 810 over communication link 1504d. Communication signal 1512 includes the content input by the users of computer system 102a, 102b, and 102c received in communication signals 1506, 1508, and 1510 by node 1502. Computer system 102a receives communication signal 1512 from network 810 over communication link 1504a. Computer system 102b receives communication signal 1512 from network 810 over communication link 1504b. Computer system 102c receives communication signal 1512 from network 810 over communication link 1504c.

For example, in the embodiment shown in FIG. 16, node 1600 may include a multicast communication interface 1604. Multicast communication interface 1604 receives a combined content signal from MCU 1602. Multicast communication interface 1604 is configured to transmit the combined content from node 1600 in a multicast manner over communications link 1504d. Multicast communication interface 1604 may include a network interface card (NIC) for interfacing with an Ethernet network, or other type of network interface.

In the manner of flowchart 1500, the participants of the conference at computer systems 102a-102c receive the content input to the conference by users of computer systems 102a-102c in a multicast manner, rather than loading the network with communication signals generated for each participant in a conventional unicast system. Furthermore, the received content is pre-combined (by node 1502), and thus computer systems 102a-102c do not need to include the functionality to combine received content. Steps 1502, 1504, and 1506 of flowchart 1500 can be repeated any number of times for subsequent content provided by any of computer systems 102a-102c during the conference.

Note that the embodiments described above may be combined in any manner. For example, the features of the embodiments described with respect to flowchart 700 of FIG. 7 may be combined with features of the embodiments described with respect to flowchart 1400 of FIG. 14, in any manner.

Furthermore, embodiments of the present invention may combine techniques of multicasting and unicasting to provide conference content to participants. For example, in an embodiment, distribution of a first portion of the conference content input by participants may be handled in a multicast manner, while distribution of a second portion of the conference content may be handled in a unicast manner.

Furthermore, in an embodiment, a single conference may combine the unicast and multicast manners of transmission. For example, for nodes or sub-networks that do not support multicast, unicast communications can be used. In another example, a participant may use a computer system that does not support multicast communications. Thus, that participant may be communicated with using unicast communications. Therefore, in some embodiments, the multicast conferencing nodes described herein, including nodes 900 and 1602 of FIGS. 9 and 16, may transmit one or more multicast and/or one or more unicast transmission signals simultaneously, directed to different participants.

Additionally, in embodiments, a conference may be conducted using one or more transmissions from the multicasting conferencing node, which may be a combination of unicast and multicast transmissions. For instance, a single transmission stream from the multicasting conferencing node may include a combination of video, audio, and/or application data. Alternatively, the video, audio, and application data may be transmitted in separate transmission streams. Furthermore, any particular stream may be a multicast stream, a unicast stream, or a combination of unicast and multicast.

### Example Computer Implementation

In an embodiment of the present invention, the networks and components of the present invention described herein are implemented using well known servers/computers, such as computer 1700 shown in FIG. 17. For example, computer systems 102, 1100, 1300, and multicasting conferencing nodes 802, 900, 1002, 1502, and 1600 can be implemented using computers 1700.

Computer 1700 can be any commercially available and well known computer capable of performing the functions described herein, such as computers available from International Business Machines, Apple, Sun, HP, Dell, Cray, etc. Computer 1700 may be any type of computer, including desktop computers, mobile computers (e.g., laptop computers, handheld computers, PDAs, appliances, other electronics devices such as a television with built-in networking capability, etc.), servers, etc.

Computer 1700 includes one or more processors (also called central processing units, or CPUs), such as a processor 1704. Processor 1704 is connected to a communication infrastructure 1702, such as a communication bus. In some embodiments, processor 1704 can simultaneously operate multiple computing threads.

Computer 1700 also includes a primary or main memory 1706, such as random access memory (RAM). Main memory 1706 has stored therein control logic 1728A (computer software), and data.

Computer 1700 also includes one or more secondary storage devices 1710. Secondary storage devices 1710 include, for example, a hard disk drive 1712 and/or a removable storage device or drive 1714, as well as other types of storage devices, such as memory cards and memory sticks. Removable storage drive 1714 represents a floppy disk drive, a magnetic tape drive, a compact disk drive, an optical storage device, tape backup, etc.

Removable storage drive 1714 interacts with a removable storage unit 1716. Removable storage unit 1716 includes a computer useable or readable storage medium 1724 having stored therein computer software 1728B (control logic) and/or data. Removable storage unit 1716 represents a floppy disk, magnetic tape, compact disk, DVD, optical storage disk, or any other computer data storage device. Removable storage drive 1714 reads from and/or writes to removable storage unit 1716 in a well known manner.

Computer 1700 also includes input/output/display devices 1722, such as monitors, keyboards, pointing devices, etc.

Computer 1700 further includes a communication or network interface 1718. Communication interface 1718 enables the computer 1700 to communicate with remote devices. For example, communication interface 1718 allows computer 1700 to communicate over communication networks or mediums 1742 (representing a form of a computer useable or readable medium), such as LANs, WANs, the Internet, etc. Network interface 1718 may interface with remote sites or networks via wired or wireless connections.

Control logic 1728C may be transmitted to and from computer 1700 via the communication medium 1742. More particularly, computer 1700 may receive and transmit carrier waves (electromagnetic signals) modulated with control logic 1728C via communication medium 1742.

Any apparatus or manufacture comprising a computer useable or readable medium having control logic (software) stored therein is referred to herein as a computer program product or program storage device. This includes, but is not limited to, computer 1700, main memory 1706, secondary storage devices 1710, removable storage unit 1716 and carrier waves modulated with control logic 1728C. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for network-based conferencing, comprising:
receiving a communication signal over a network at a node from a first computer system of a plurality of computer systems having users participating in a network-based conference, the communication signal including input content regarding the conference from a user of the first computer system; and
multicasting the input content over the network from the node to at least a portion of the plurality of computer systems.

2. The method of claim 1, wherein said multicasting comprises:
multicasting the input content over the network from the node to all of the plurality of computer systems except for the first computer system.

3. The method of claim 1, further comprising:
receiving a second communication signal over the network at the node from a second computer system of the plurality of computer systems of the network-based conference, the second communication signal including second input content regarding the conference from a second user of the second computer system; and
multicasting the second input content over the network from the node to at least a portion of the plurality of computer systems.

4. The method of claim 1, wherein said multicasting the second input content over the network from the node to at least a portion of the plurality of computer systems comprises:
multicasting the second input content over the network from the node to all of the plurality of computer systems except for the second computer system.

5. The method of claim 1, wherein said input content includes audio information.

6. The method of claim 1, wherein said input content includes video information.

7. The method of claim 1, further comprising:
receiving the multicasted input content at a second computer system of the plurality of computer systems; and
playing audio of the received multicasted input content at the second computer system for a second user of the second computer system.

8. The method of claim 7, further comprising:
displaying video of the received multicasted input content at the second computer for the second user.

9. A method for network-based conferencing, comprising:
receiving a plurality of communication signals over a network at a node from a plurality of computer systems having users participating in a network-based conference, each of the plurality of communication signals including input content regarding the conference from a corresponding computer system;
combining the input content received in the plurality of communication signals; and
multicasting the combined input content from the node over the network to at least a portion of the plurality of computer systems.

10. The method of claim 9, further comprising:
receiving a request to add a user to the conference;
adding an internet protocol (IP) address corresponding to a computer system of the user to a multicast group address; and
generating a multicast distribution tree.

11. The method of claim 10, wherein said multicasting comprises:
multicasting the combined input content to the plurality of computer systems according to the multicast distribution tree.

12. The method of claim 10, wherein said multicasting comprises:
generating a data packet that includes the multicast group address.

13. The method of claim 9, wherein said multicasting comprises:
generating a data packet that includes a plurality of unicast addresses corresponding to the plurality of computer systems.

14. The method of claim 9, wherein said input content includes audio information.

15. The method of claim 9, wherein said input content includes video information.

16. A communication network, comprising:
a multicasting conferencing node configured to receive a plurality of communication signals over a network from a plurality of computer systems having users participating in a network-based conference, each of the plurality of communication signals including input content regarding the conference from a corresponding computer system;
wherein the multicasting conferencing node is configured to multicast the received input content from the node over the network to at least a portion of the plurality of computer systems.

17. The communication network of claim 16, wherein the multicasting conferencing node is further configured to combine the input content received in the plurality of communication signals prior to multicasting the received input content from the node over the network.

18. The communication network of claim 17, wherein the multicasting conferencing node comprises:
an audio combiner.

19. The communication network of claim 17, wherein the multicasting conferencing node comprises:
a video combiner.

20. The communication network of claim 16, wherein the input content includes audio information.

21. The communication network of claim 16, wherein the input content includes video information.

22. The communication network of claim 16, wherein the multicasting conferencing node is configured to generate a data packet that includes a multicast group address.

23. The communication network of claim 16, wherein the multicasting conferencing node is configured to generate a data packet that includes a plurality of unicast addresses corresponding to at least a portion of the plurality of computer systems.
